(19) United States
(12) Patent Application Publication
(10) Pub. No.: US 2026/0070024 A1
(43) Pub. Date: Mar. 12, 2026

(54) Asymmetric Hollow Fiber Membrane

(71) Applicant: Solventum Intellectual Properties Company, E. Maplewood, MN (US)

(72) Inventors: Jinsheng Zhou, Woodbury, MN (US); William J. Kopecky, Hudson, WI (US); Nathan S. Brady, Maplewood, MN (US); James C. DeLozier, Fort Mill, SC (US)

(21) Appl. No.: 19/110,068

(22) PCT Filed: Sep. 5, 2023
(86) PCT No.: PCT/IB2023/058784

§ 371 Date: Mar. 8, 2025

Related U.S. Application Data
(60) Provisional application No. 63/375,069, filed on Sep. 9, 2022.
(60) Provisional application No. 63/514,854, filed on Jul. 21, 2023.

(51) Int. Cl. B01D 69/08; B01D 19/00; B01D 53/22; B01D 63/02; B01D 67/00; B01D 69/02; B01D 71/26; B01D 71/80

(52) U.S. Cl. CPC B01D 69/082; B01D 53/228; B01D 63/02; B01D 67/0027; B01D 67/0083; B01D 69/02; B01D 69/088; B01D 71/26; B01D 71/262; B01D 71/80; B01D 19/0031; B01D 2257/504; B01D 2325/023; B01D 2325/0231; B01D 2325/0233; B01D 2325/04

(57) ABSTRACT

Asymmetric hollow fiber membranes comprising a porous substrate layer and a skin layer are described. The skin layer is a copolymer of polymethyl pentene and polypropylene. Gas separation articles made using such hollow fiber membranes, as well as methods of making and using such hollow fiber membranes and gas separation articles are also described.

### FIELD

The present disclosure relates to hollow fiber membranes having a porous substrate layer and a skin layer comprising a copolymer of polymethyl pentene and polypropylene. Gas separation articles made using such hollow fiber membranes, as well as methods of making and using such hollow fiber membranes and gas separation articles are also described.

### SUMMARY

Briefly, in one aspect, the present disclosure provides asymmetric hollow fiber membranes comprising a porous substrate comprising a polyolefin polymer and having a plurality of pores surrounding an internal lumen, and a skin layer overlaying the porous substrate, wherein the skin layer comprises a copolymer comprising at least 80 weight percent 4-methyl-1-pentene units and at least 5 weight percent propylene units, wherein the total weight percent of 4-methyl-1-pentene units and propylene units is at least 98%, based on the total weight of monomer units in the copolymer. In some cases, an additional porous substrate layer may overlay the skin layer.

In another aspect, the present disclosure provides a separation article comprising a plurality of such asymmetric hollow fiber membranes arranged substantially parallel in an array pattern and fastened together.

In yet another aspect, the present disclosure provides methods of making such asymmetric hollow fiber membranes.

### BRIEF DESCRIPTION OF THE DRAWINGS

FIG. 1 illustrates the cross-section of an exemplary asymmetric hollow fiber membrane.

FIG. 2 illustrates the cross-section of another exemplary asymmetric hollow fiber membrane.

FIG. 3 illustrates the cross-section of another exemplary asymmetric hollow fiber membrane.

### DETAILED DESCRIPTION

Microporous hollow fibers can be used to separate components from a fluid stream on the basis of, e.g., size, phase and charge. Microporous hollow fibers often employ materials having a controlled porosity and a pore size on the order of a few micrometers, and have many uses including, for example, separation, filtration, diffusion, and barrier applications. These broad applications have been practically applied in medical devices, electrochemical devices, chemical processing devices, pharmaceutical devices and water purification, to name a few.

The performance of microporous hollow fiber membranes is often a complex function of the particular end-use application as well as the composition and structure of the hollow fiber (e.g., the hollow fiber diameter, wall thickness, porosity, and pore size). Often, these and other variables are tailored to the particular end-use application. For example, a membrane with a gas permeable separation layer may be used to provide selective gas/gas and gas/liquid passage.

Membrane contactors useful for gas/liquid separation applications may be fabricated using asymmetric microporous hollow fiber membranes. Asymmetric microporous hollow fiber membranes, i.e., hollow fiber membranes comprising two or more layers, allow the selective passage of certain dissolved gases while blocking liquid water or other aqueous liquids. Such hollow fiber membranes may be used in a membrane contactor to achieve gas/liquid separation in applications such as the degassing of aqueous printing inks during printing and the separation of dissolved gases such as carbon dioxide or methane from aqueous brines used to enhance petroleum recovery. Other exemplary uses include the removal of dissolved gases from fluids used in electroplating or microelectronic components, dissolved gas control of beer, wine and liquor, extracorporeal membrane oxygenation, oxygen enrichment from air, and carbon capture.

U.S. Pat. No. 10,010,835 B2 describes an asymmetric hollow fiber membrane including a thermoplastic polymer substrate defining a plurality of micropores and a polymethyl pentene (PMP) polymer skin positioned on the thermoplastic polymer substrate. International Patent Publication WO2020/136568 A1 describes an asymmetric hollow fiber membrane including a porous substrate having a multiplicity of pores and a skin layer overlaying the porous substate. The porous substrate includes a first semi-crystalline thermoplastic polyolefin (co)polymer and a nucleating agent effective to achieve nucleation. The skin layer includes a second semi-crystalline thermoplastic polyolefin copolymer derived by polymerizing at most 98 weight percent of 4-methyl-1-pentene monomer with at least 2 weight percent of linear or branched alpha olefin monomers.

Despite the success of these and other asymmetric hollow fiber membranes, there remains a need for further improvements. For example, there is a desire to provide the required levels of porosity and selectively without the use of nucleating agents, to improve the interlayer adhesion between the substrate and skin layers, and to increase the tensile strength (force at break). Surprisingly, the present inventors discovered that one or more of these advantages could be achieved when using a polyolefin substrate layer combined with a skin layer comprising a polymethyl pentene copolymer containing at least 5 percent by weight polypropylene.

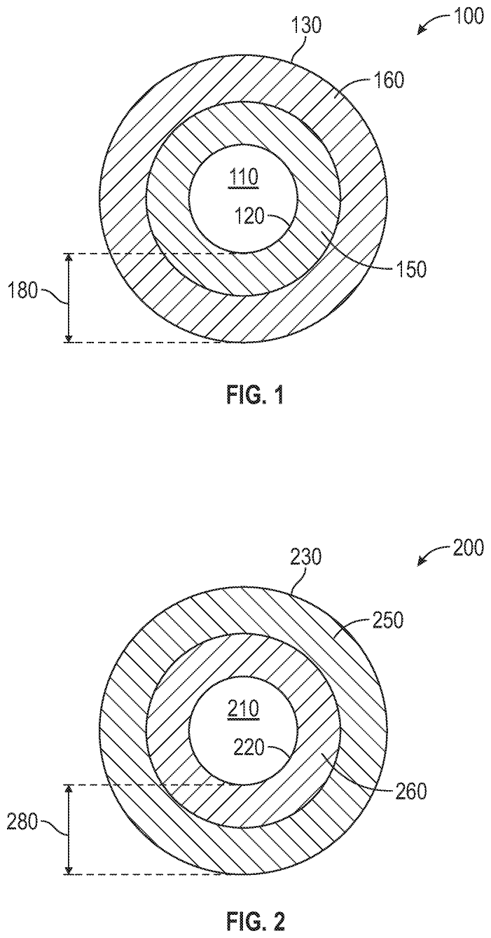

Generally, an asymmetric hollow fiber membrane comprises at least two layers forming a boundary around a hollow, central lumen. The cross-section of an exemplary asymmetric hollow fiber membrane is shown in FIG. 1. Boundary 180 comprises porous substrate 150 and skin layer 160, surrounding lumen 110 of asymmetric hollow fiber membrane 100. In this example, porous substrate 150 comprises surface 120 of lumen 110, i.e., the surface of boundary 180 immediately adjacent to the lumen. Skin layer 160 comprises outer surface 130 of asymmetric hollow fiber membrane 100, i.e., the surface of boundary 180 that is exposed to the ambient environment.

In some embodiments, the relative positions of the layers may be reversed. For example, as shown in FIG. 2, boundary 280 comprises porous substrate 250 and skin layer 260, surrounding lumen 210 of asymmetric hollow fiber membrane 200. In this example, porous substrate 250 comprises outer surface 230 of asymmetric hollow fiber membrane 200, while skin layer 260 comprises surface 220 of lumen 210.

As used herein, the terms “overlay” and “overlaying” refer to layers that surround a common lumen and do require any particular spatial orientation of the layers. Thus, referring to FIG. 1, porous substrate 150 overlays skin layer 160, and skin layer 160 overlays porous substrate 150. Similarly, referring to FIG. 2, porous substrate 250 overlays skin layer 260, and skin layer 260 overlays porous substrate 250.

Generally, the porous substrate comprises a polyolefin polymer, e.g., a polyolefin homopolymer or copolymer. In some embodiments, the polymer comprises polypropylene, e.g., polypropylene homopolymers. Generally, any suitable polypropylene may be used. Suitable polypropylene homopolymers include, e.g., those available from Total Petrochemicals (Houston, Texas) under the trade designation FINA, those available from Lyondel-Basell Industries (Pasadena, California) under the trade designation PRO-FAX, those available from INEOS Olefoins & Polymers, USA (Carson, California) under the trade designation INEOS, and those available from Exxon-Mobil Chemical Company (Spring, Texas).

The thickness of the porous substrate layer can depend on the particular application in which the microporous asymmetric hollow fiber is employed. In some embodiments, the porous substrate is at least 5, e.g., at least 10 or at least 20 micrometers thick. In some embodiments, the porous substrate is no greater than 20, e.g., no greater than 100, or even no greater than 50 micrometers thick, e.g., 5-200, 10-100 μm, 15-75 μm, 20-50 μm, or even 25-35 micrometers thick.

The skin layer comprises a copolymer of 4-methyl-1-pentene and propylene repeat units. Generally, the copolymer of the skin layer (also referred to as the skin resin) comprises at least 80 weight percent 4-methyl-1-pentene units and at least 5 weight percent propylene units, wherein the total weight percent of 4-methyl-1-pentene units and propylene units is at least 98 wt. %, based on the total number of monomer units in the skin resin. As used herein, the term “monomer unit” refers to the structure of the monomer in its polymerized form. For example, for propylene (CH₂═CH—CH₃) the corresponding propylene unit is —CH₂—CH(CH₃)—.

Generally, the skin resin predominantly comprises 4-methyl-1-pentene units, i.e., at least 80 wt. %. In some embodiments, the skin resin comprises at least 84 wt. %, e.g., at least 90 wt. % of 4-methyl-1-pentene units, based on the total weight of monomer units in the skin resin. In some embodiments, the skin resin comprises no greater than 95 wt., e.g., no greater than 94 wt. % of 4-methyl-1-pentene units (e.g., 84 to 94, or even 90 to 94 wt. % of 4-methyl-1-pentene units).

Unlike the PMP-based skin resins of the prior art, the skin resins of the present disclosure contain relatively high amounts of polypropylene, i.e., at least 5 weight percent, e.g., at least 6 wt. %, based on the total weight of monomer units in the skin resin. In some embodiments, the skin resin comprises no greater than 20, e.g., no greater than 16, no greater than 10, or even no greater than 8 wt. % of propylene units (e.g., 6 to 16 wt. %, e.g., 6 to 8 wt. % of propylene units).

In some embodiments, the total weight percent of 4-methyl-1-pentene units and propylene repeat units is at least 99 wt. %, at least 99.5 wt. %, or even 100 wt. %, based on the total weight of monomer units in the skin resin. In some embodiments, the skin resin may contain additional comonomers, e.g., at least one additional alpha-olefin comonomer such as ethylene, 1-hexene, and 1-octene. If present, the skin resin may comprise a combined amount of 0.05 to 2, e.g., 0.1 to 1, or even 0.1 to 0.5 wt. % of such additional comonomers.

In some embodiments, the skin layer is not permeable to liquids, e.g., a solid skin without pores or a micro-porous skin without permeability to liquids but with permeability to gases. In some embodiments, the skin layer may promote gas absorption and/or degassing of a liquid efficiently even though the skin layer is not permeable to liquids.

The thickness of the skin layer can depend on the particular application in which the microporous asymmetric hollow fiber is employed. Generally, decreasing the thickness of the skin layer results in a higher gas flux and a more efficient asymmetric microporous asymmetric hollow fiber membrane. In some embodiments, the skin layer may be no greater than 20 micrometers, e.g., no greater than 5 or even no greater than 3 micrometers in thickness. In some embodiments, the skin layer is at least 0.1, e.g., at least 0.5 micrometers thick, e.g., 0.1 to 20 micrometers thick, e.g., 0.1 to 10, 0.5 to 10, 0.5 to 5, or 1 to 3 micrometers thick.

In some cases, the boundary may comprise one or more additional layers, any one of which may comprise the outer surface of the asymmetric hollow fiber membrane, the surface of the lumen, or an intermediate layer. Similarly, when one or more additional layers are present, one or both of the porous substrate and the skin layer may be an intermediate layer. In any case, each layer may be described as overlaying the other layers.

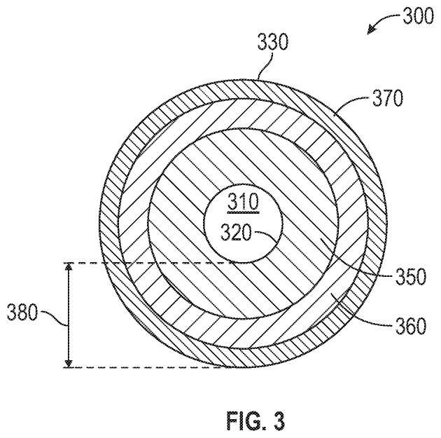

For example, an asymmetric hollow fiber membrane may comprise at least three layers forming a boundary around a hollow, central lumen. The cross-section of such an exemplary asymmetric hollow fiber membrane is shown in FIG. 3. Boundary 380 comprises first porous substrate 350, skin layer 360, and second porous substrate 370 surrounding lumen 310 of asymmetric hollow fiber membrane 300. In this example, first porous substrate 350 comprises surface 320 of lumen 310, i.e., the surface of boundary 380 immediately adjacent to the lumen. Second porous substrate 370 comprises outer surface 330 of asymmetric hollow fiber membrane 300, i.e., the surface of boundary 380 that is exposed to the ambient environment. Skin layer 360 is sandwiched between first porous substrate 350 and second porous substrate 370.

In some cases, the first and second porous substrates comprise the same material. In some cases, different materials may be used to form the first and second porous substrates. For example, in some cases, the materials used to form the first and second porous substrate may be independently selected from the materials described above.

The second porous substrate may act as a protective layer, protecting the thin skin layer from damage during subsequent processing such as stretching. Generally, the thickness of the second porous substrate is less than the thickness of the first porous substrate. In some cases, the thickness of the second porous substrate is no greater than 10 micrometers, e.g., no greater than 5 or even no greater than 3 micrometers. In some cases, thickness of the second porous substrate is at least 0.5 micrometers, e.g., at least 1 or even no greater than 2 micrometers. In some cases, second porous substrate is 0.5 to 10 micrometers thick, e.g., 0.5 to 5, 0.5 to 3, or even 1 to 3 micrometers thick.

The hollow fiber membranes described herein can be fabricated using various known production methods depending on the desired asymmetric hollow fiber structure and the desired asymmetric hollow fiber composition. Microporous membranes can be fabricated according to various production techniques, such as the wet process, the particle stretch process, and the dry-stretch process (also known as the CELGARD process).

Generally, in the wet process, (also known as the phase inversion process, the extraction process, or the TIPS process), a polymeric raw material is mixed with an oil, a solvent, and/or another material. This mixture is extruded, and pores are formed when such an oil, solvent, and/or other material is removed. These films may be stretched before or after the removal of the oil, solvent, and/or other material.

Generally, in the particle stretch process, the polymeric raw material is mixed with particulate, this mixture is extruded, and pores are formed during stretching when the interface between the polymer and the particulate fractures due to the stretching forces.

The dry process differs from the wet process and the particle stretch process by producing a porous asymmetric hollow fiber typically without addition of a processing oil, oil, solvent, plasticizer, and/or the like, or a particulate material. Therefore, although other processes may be used, the substrate and skin materials of the present disclosure can be used in a dry-stretch process to produce asymmetric hollow fiber membranes with the desired porosity without the need for liquid or particulate additives. Therefore, preferably, the microporous membranes are formed via the CELGARD® process, also referred to as the “extrude, anneal, stretch” or “dry stretch” process, whereby a semi-crystalline polymer is extruded to provide an asymmetric hollow fiber precursor and a porosity is induced in the microporous substrate by stretching the extruded precursor.

In a typical dry process, the resins of the skin layer and the substrate layer (along with any optional additional layers) are co-extruded through an annular co-extrusion die to form the asymmetric fiber precursor. The asymmetric fiber precursor is then stretched to form the asymmetric hollow fiber comprising a porous substrate layer and a skin layer surrounding a hollow lumen.

Generally, the asymmetric fiber precursor is stretched to form an open porous structure by uniaxial extension of at least 10% and up to 500%, e.g., from 50% to 300%, or from 100% to 200%. Stretching can be performed using single or multi-stage cold stretching, optionally followed by single or multi-stage hot stretching. Generally, the cold stretching temperature may be, e.g., from 20 to 90° C., e.g., from 30 to 70° C. The hot stretching temperature may be, e.g., from 100 to 200° C., e.g., from 120 to 170° C.

In some embodiments, the asymmetric fiber precursor may be annealed prior to stretching. For example, the asymmetric fiber precursor may be exposed to temperatures of, e.g., 100 to 150° C. for, e.g., 5 to 30 minutes.

In some embodiments, the asymmetric hollow fiber membranes may be heat-treated or heat-set after stretching to reduce the stress in the fibers. The heat-setting temperature is typically selected to be higher than the hot stretching temperature by at least 5° C., at least 10° C., or even at least 15° C. The heating setting duration is typically selected to be at least 30 seconds, at least one minute, or at least 90 seconds. Alternatively, or additionally, the asymmetric hollow fiber membranes may be subjected to a stress relaxation step, allowing fiber lengths to shrink to a certain extent, e.g., at least 2%, or even at least 5%.

In some embodiments, when the skin layer is adjacent the porous substrate, the polymer of the skin layer may diffuse into the pores of the porous substrate. Such diffusion can improve the interlayer adhesion but may also reduce the gas transport through the porous layer.

Examples. The materials used in the Examples are summarized in Table 1.

TABLE 1
Summary of materials used in the preparation of the examples.

| Name | Description | Trade Name and Source |
|---|---|---|
| PP-1 | Polypropylene resin | FF030F2 (Braskem America, Inc.) |
| PP-2 | Polypropylene resin | PPH3462 (Total Chemicals Co.) |
| PP-3 | Polypropylene resin | PPH3766 (Total Chemicals Co.) |
| PP-4 | Polypropylene resin | PPH3860 (Total Chemicals Co.) |
| PMP-A | methyl pentene/ethylene/ | MX002 (Mitsui Chemicals, Inc.) |
| | hexene copolymer | |
| PMP-B | methyl pentene/propylene | EP1001 (Mitsui Chemicals, Inc.) |
| | copolymer | |
| PMP-C | methyl pentene/propylene | EP1013 (Mitsui Chemicals, Inc.) |
| | copolymer | |

Skin Resin Analysis. ¹³C NMR analysis of two skin resins (PMP-B and PMP-C) were conducted after dissolving them into trichloroethylene (TCE) at elevated temperature using a BRIKER 600 MHz spectrometer with an inverse cryoprobe at 400 k (Bruker Company). Spectra were compared to polyethylene and polypropylene. Each component was quantitively analyzed as summarized in Table 2. As shown, these resins contain much higher amounts of propylene than PMP-A, which has the highest-level co-monomer in PMP grades and is typically used for skin layers in coextruded hollow fiber membranes.

TABLE 2
Composition of PMP skin resins (wt. %).

| | 4-methyl-1- | | | | Total |
|---|---|---|---|---|---|
| Name | pentene | propylene | ethylene | 1-hexene | comonomers |
| PMP-A | 94.0 | — | 3.9 | 2.3 | 6.1 |
| PMP-B | 85.3 | 14.4 | 0.3 | — | 14.7 |
| PMP-C | 92.8 | 6.9 | 0.3 | — | 7.2 |

Differential scanning calorimetry was performed on each of the PMP resins using a heating ramp of 10.0° C. per minute to 200° C. and a cooling ramp of 10.0° C. per minute to −20° C. PMP-A showed a melting peak at 224° C. and a crystallization peak at 211° C. In contrast, PMP-B showed neither a melting nor a crystallization peak. PMP-C showed a melting peak at 130° C., but no crystallization peak. Thus, PMP-B and PMP clearly exhibit different behavior than semi-crystalline PMPs such as PMP-A.

Asymmetric fiber precursors (AFP) were prepared as follows. The skin and substrate resins were extruded by two separate single screw extruders. The two melts were fed into a fiber spinning die by melt gear pumps. The die had annular orifices and one center hole for core air supply. The coextruded asymmetric hollow fiber precursors were quenched by an air ring which provided a fiber with a uniform environment. The fibers in their molten state were drawn down by three sets of godet rolls at a fiber drawing speed of 100 meters per minute. The materials, extruder temperatures and melt pump rate (cubic centimeters per minute) for the substrate and skin, along with the die temperature are shown in Table 3.

TABLE 3
Asymmetric fiber precursor formation parameters.

| | Substrate | | | | | | |
|---|---|---|---|---|---|---|---|
| | | Temp. | Rate | Skin | Temp. | Rate | Die |
| Sample | Material | (° C.) | (cc/min.) | Material | (° C.) | (cc/min.) | (° C.) |
| AFP-1 | PP-1 | 120-230 | 4.41 | PMP-C | 141-250 | 0.81 | 230 |
| AFP-2 | PP-1 | 120-230 | 4.41 | PMP-C | 141-250 | 0.40 | 230 |
| AFP-3 | PP-2 | 175-230 | 4.41 | PMP-C | 150-220 | 0.40 | 220 |
| AFP-4 | PP-1 | 175-230 | 4.41 | PMP-B | 150-220 | 0.40 | 220 |
| AFP-5 | PP-1 | 175-232 | 4.41 | 70% PMP-C/ | 150-220 | 0.40 | 230 |
| | | | | 30% PP-3 | | | |
| AFP-6 | PP-1 | 175-233 | 4.41 | 70% PMP-C/ | 150-220 | 0.40 | 230 |
| | | | | 30% PP-4 | | | |
| AFP-7 | PP-1 | 120-230 | 4.41 | 50% PMP-C/ | 137-250 | 0.96 | 255 |
| | | | | 50% PMP-A | | | |

Asymmetric hollow fiber membranes were prepared from the asymmetric fiber precursors by annealing followed by dry-stretching. For annealing, asymmetric fiber precursor bundles (about 25 cm long) were prepared by taping them together at one end. Each bundle was then annealed in a convection oven set at a temperature as show in Tables 4-6. The annealing time for each asymmetric fiber precursor bundle was 15 minutes at the setting temperature. For dry (hot/cold) stretching, the bundles (annealed or not annealed) were clamped in a temperature-controlled environmental chamber of an Instron Mechanical Tester (Model 5969, Norwood, MA). 127 mm (5 inch) long fibers were cold stretched at a stretching rate 600 mm/minute at 25° C. and subsequently hot-stretched with stretching rate 30 mm/min at 120° C. Total extension ratios after 10% relaxation are shown in Tables 4-6.

The resulting CO₂ flow rate (GPU) and CO₂/N2 selectivity were measured as follows.

The Gas Permeability Test is used as an integrity test for the non-porous skin layer as well as a performance test for the hollow fiber membranes. Loop modules were prepared by sealing hollow fibers together in a 0.65 cm (¼ inch) OD nylon tube with an epoxy adhesive. The lumen of each fiber was exposed by cutting the sealing tube with a razor blade. Each loop module contained 10 fibers with about 10.2 cm (4 inch) effective lengths.

The Gas Permeability Test was conducted using a custom designed test stand. The stand was equipped with cylinders of pure gases (CO₂ and N₂), pressure gauges, and in-line gas flow meters. The principle of this testing is to supply a pure gas into fiber lumen and to measure the rate of the gas leaking through fiber walls into ambient environment. Each fiber loop module was tested with CO₂ and N₂, respectively. Gas pressure in the fiber lumen was typically set at about 207 kPa (30 psi). Both the gas pressure and the gas flow rate were monitored by data acquisition software, and data were acquired when both the pressure and gas flow rate were stabilized.

The gas permeation rate (GPU) of each fiber membrane was calculated as follows

$$Gas permeation ( GPU ) = \frac{Q}{Δ P * A} * 1 {0}^{6}$$

wherein: Q is the gas flow rate (scc/sec);
ΔP is the gas pressure differential reading (cm Hg); and
A is the fiber outer surface area (cm²)

The fiber gas selectivity has been used as an indicator of skin integrity. The selectivity of PMP is typically in the range 11-13 according to a literature report (Polymer, 1989, 30, P1357). Any fiber with gas Selectivity below 8 was considered to have a defective skin. The CO₂/N₂ selectivity of fibers was calculated from gas permeation rates of each gas as shown below.

$$Selectivity = \frac{{CO}_{2} ( GPU )}{{N}_{2} ( GPU )} .$$

Samples annealed at 25° C. were prepared using PMP-C (AFP-2 and AFP-3) and PMP-B (AFP-4) as the skin resin. The process conditions and results are summarized in Table 4.

TABLE 4
Dry-stretched asymmetric hollow fiber membranes.

| | | Substrate | Skin | Stretch | Fiber OD | CO₂ | Selectivity |
|---|---|---|---|---|---|---|---|
| Sample | Precursor | Resin | Resin | ratio | (microns) | (GPU) | CO₂/N₂ |
| 1 | AFP-2 | PP-1 | PMP-C | 100% | 259 | 33 ± 1 | 15 ± 2 |
| 2 | AFP-3 | PP-2 | PMP-C | 100% | 250 | 44 ± 2 | 13 ± 3 |
| 3 | AFP-3 | PP-2 | PMP-C | 150% | 249 | 48 ± 1 | 13.2 ± 0.4 |
| 4 | AFP-3 | PP-2 | PMP-C | 200% | 232 | 57 ± 8 | 7 ± 3 |
| 5 | AFP-4 | PP-1 | PMP-B | 100% | 300* | 8 | 19 |

*Not measured, calculated at a fiber diameter of 300 microns.

Additional samples were prepared using PMP-C modified by the addition polypropylene (AFP-5 and AFP-6) as the skin resin. PP-1 was used as the substrate resin in all samples. The samples were annealed at 25° C. and the results are summarized in Table 5 and compared to Sample 1, which had the unmodified PMP-C skin resin.

TABLE 5
Dry-stretched asymmetric hollow fiber
membranes with modified skin layers.

| | | Stretch | Fiber OD | CO₂ | Selectivity |
|---|---|---|---|---|---|
| Sample | Precursor | ratio | (microns) | (GPU) | CO₂/N₂ |
| 1 | AFP-2 | 100% | 259 | 33 ± 1 | 15 ± 2 |
| 6 | AFP-5 | 100% | 262 | 17.5 | 10.5 |
| 7 | AFP-6 | 200% | 257 | 15.9 | 11.3 |

Samples were also prepared using PMP-C and modified PMP-C as the skin resin. The substrate resin was PP-1 in all samples. These samples were annealed at temperatures greater than 100° C. The results are in Table 6.

TABLE 6
High-temperature-annealed asymmetric hollow fiber membranes.

| | | Anneal | Total stretch | Fiber OD | CO₂ | Selectivity |
|---|---|---|---|---|---|---|
| Sample | Precursor | Temp (° C.) | ratio | (microns) | (GPU) | CO₂/N₂ |
| 8 | AFP-1 | 120 | 100% | 300* | 23 ± 4 | 2.9 ± 0.1 |
| 9 | AFP-5 | 140 | 100% | 300* | 124 | 1 |
| 10 | AFP-6 | 140 | 100% | 300* | 55 ± 28 | 1.9 ± 0.7 |
| 11 | AFP-7 | 140 | 100% | 300* | 15.0 ± 0.3 | 15.3 ± 0.2 |

*Not measured, calculated at a fiber diameter of 300 microns.

Three-layer asymmetric fiber precursors (AFP) were prepared as follows. The skin and substrate resins were extruded by two separate single screw extruders. The two melts were fed into another fiber spinning die by melt gear pumps. The die had annular orifices and one center hole for core air supply. In the die, the substrate resin melt was allowed to split into two streams to sandwich the skin melt before exiting the die face. The coextruded asymmetric hollow fiber precursors were quenched by an air ring which provided a fiber with a uniform environment. The fibers in their molten state were drawn down by three sets of godet rolls at a fiber drawing speed of 100 meters per minute. The materials, extruder temperatures and melt pump rate (cubic centimeters per minute) for the substrate material and skin material, along with the die temperature are shown in Table 7.

The cross-section of AFP-10 was analyzed by electron scanning microscopy (SEM, Model Hitachi TM4000 plus II, obtained from Hitachi High-Tech Corporations, Japan). A three-layer construction was clearly seen: a thick inner layer (44.3 micrometers), a thin middle layer (1.21 micrometers) and a thin outer layer (2.59 micrometers). The middle layer was formed from skin material; and both the inner layer and the outer layer were formed from the substrate material.

TABLE 7
Three-layer asymmetric fiber precursor formation parameters

| | Substrate | | | Skin | | | |
|---|---|---|---|---|---|---|---|
| | | | Rate | | | Rate | |
| | | Temp. | (cc/ | | Temp. | (cc/ | Die |
| Sample | Material | (° C.) | min.) | Material | (° C.) | min.) | (° C.) |
| AFP-8 | PP-1 | 177-231 | 5.11 | PMP-C | 150-230 | 0.50 | 225 |
| AFP-9 | PP-1 | 177-231 | 5.11 | PMP-C | 150-230 | 0.29 | 225 |
| AFP-10 | PP-1 | 177-231 | 5.11 | PMP-C | 150-230 | 0.20 | 225 |
| AFP-11 | PP-1 | 177-231 | 3.35 | PMP-C | 150-230 | 0.50 | 225 |
| AFP-12 | PP-1 | 177-231 | 3.35 | PMP-C | 150-230 | 0.30 | 225 |
| AFP-13 | PP-1 | 177-231 | 3.35 | PMP-C | 150-230 | 0.20 | 225 |

Three-layer asymmetric hollow fiber membranes were prepared from these asymmetric fiber precursors by annealing followed by dry-stretching. For annealing, asymmetric fiber precursor bundles (about 25 cm long) were prepared by taping them together at one end. As the skin layer was protected by the second substrate layer, processing these bundles at elevated temperature became more practical without generating defects in the skin layer.

Each bundle was annealed in a convection oven set at a temperature of 140° C. The annealing time for each asymmetric fiber precursor bundle was 15 minutes at the setting temperature. For dry (hot/cold) stretching, the bundles were clamped in a temperature-controlled environmental chamber of an Instron Mechanical Tester (Model 5969, Norwood, MA). 127 mm (5 inch) long fibers were cold stretched at a stretching rate 600 mm/minute at 25° C. and subsequently hot-stretched with stretching rate 30 mm/min at 120 C. Total extension ratios after 10% relaxation are shown in Table 8.

The resulting CO₂ flow rate (GPU) and CO₂/N2 selectivity were measured according to the methods described above. These results are also summarized in Table 8.

TABLE 8
Dry-stretched three-layer asymmetric hollow fiber membranes.

| | | Stretch | Fiber OD | CO₂ | Selectivity |
|---|---|---|---|---|---|
| Sample | Precursor | ratio | (microns) | (GPU) | CO₂/N₂ |
| 12 | AFP-8 | 100% | 277 +/− 5 | 32.7 +/− 2.8 | 8.5 +/− 1.6 |
| 13 | AFP-9 | 100% | 286 +/− 5 | 38.5 +/− 3.5 | 11.6 +/− 1.9 |
| 14 | AFP-10 | 100% | 277 +/− 7 | 46.9 +/− 1.0 | 17.3 +/− 1.7 |
| 15 | AFP-10 | 120% | 287 +/− 30 | 56.0 +/− 1.9 | 18.2 +/− 0.2 |
| 16 | AFP-10 | 150% | 259 +/− 3 | 70.5 +/− 2.5 | 16.5 +/− 0.7 |
| 17 | AFP-10 | 180% | 251 +/− 5 | 62.9 +/− 5.8 | 17.9 +/− 1.0 |
| 18 | AFP-11 | 100% | 249 +/− 12 | 19.2 +/− 2.4 | 4.7 +/− 0.8 |
| 19 | AFP-12 | 100% | 244 +/− 17 | 22.0 +/− 3.5 | 13.2 +/− 1.6 |
| 20 | AFP-13 | 100% | 259 +/− 40 | 40.5 +/− 7.0 | 15.7 +/− 0.4 |

Samples 14-17 were obtained from the same three-layer asymmetric fiber precursors but with different stretching ratios. As can be seen, gas fluxes increase with the increasing stretching ratio up to 150%; then decrease with further increasing stretching ratio. However, gas selectivity remains constant. It appears that a thinner skin layer was formed with increasing stretching ratios without generating any micropores or defects in the protected skin layer. However, when stretching up to 180%, the resistance of the porous substrate layers to gas flow may become significant, which may have caused the flux decline.

Sample 14 was further characterized by examining the exterior and interior surfaces by high resolution electron scanning microscopy (Field Emission-SEM, Model Hitachi S-4700, obtained from Hitachi High-Tech Corporations, Japan). Both the exterior and interior surfaces were found to have porous microstructures.

Separation articles may be prepared from the asymmetric hollow fiber membranes of the present disclosure using known methods such as those described in International Publication No. WO 2021/105838 A1. For example, a plurality of asymmetric hollow fiber membranes may be arranged substantially parallel in an array pattern and fastened together by, e.g., knitting or tying together the individual hollow fiber membranes using string, thread, yarn, or the like. In some embodiments, the array may be pleated, folded, or rolled into a cylinder or a cassette.

1. An asymmetric hollow fiber membrane comprising a first porous substrate comprising a polyolefin polymer and having a plurality of pores surrounding an internal lumen, and a skin layer overlaying the porous substrate, wherein the skin layer comprises a copolymer comprising at least 80 weight percent 4-methyl-1-pentene units and at least 5 weight percent propylene units, wherein the total weight percent of 4-methyl-1-pentene units and propylene units is at least 98%, based on the total weight of monomer units in the copolymer, wherein the polyolefin polymer comprises polypropylene.

2. The asymmetric hollow fiber membrane of claim 2, wherein the copolymer of the skin layer comprises 84 to 94 weight percent 4-methyl-1-pentene units and 6 to 16 weight percent propylene units, optionally wherein the copolymer of the skin layer comprises 90 to 94 weight percent 4-methyl-1-pentene units and 6 to 8 weight percent propylene units.

3. The asymmetric hollow fiber membrane according to claim 1- or 2, wherein the copolymer of the skin layer further comprises 0.1 to 0.5 weight percent of at least one additional alpha-olefin comonomer.

4. (canceled)

5. The asymmetric hollow fiber membrane according to claim 1, wherein the pores have a diameter of from 0.01 to 1 micrometer.

6. The asymmetric hollow fiber membrane according to claim 1, wherein the asymmetric hollow fiber membrane has a porosity of from 5 to 80%, optionally wherein the porosity is at least 20%.

7. The asymmetric hollow fiber membrane according to claim 1, wherein the skin layer is nonporous.

8. The asymmetric hollow fiber membrane according to claim 1, wherein the skin layer has a thickness of from 0.1 to 20 micrometers, optionally from 0.5 to 10 micrometers.

9. The asymmetric hollow fiber membrane according to claim 1, wherein the first porous substrate has a thickness of from 5 to 200 micrometers.

10. The asymmetric hollow fiber membrane according to claim 1, wherein the first porous substrate comprises a surface of the lumen.

11. The asymmetric hollow fiber membrane according to claim 1, wherein the skin layer comprises an outer surface of the asymmetric hollow fiber membrane.

12. The asymmetric hollow fiber membrane according to claim 1, wherein the skin layer comprises a surface of the lumen.

13. The asymmetric hollow fiber membrane according to claim 1, further comprising a second porous substrate comprising a polyolefin polymer and having a plurality of pores, wherein the first porous substrate comprises a surface of the lumen, the second porous substrate comprises an outer surface of the asymmetric hollow fiber membrane, and the skin layer is sandwiched between the first and second porous substrates.

14. The asymmetric hollow fiber membrane according to claim 13, wherein the thickness of the second porous substrate is from 0.5 to 10 micrometers

15. A separation article comprising a plurality of the asymmetric hollow fiber membranes according to claim 1 arranged substantially parallel in an array pattern and fastened together.

16. The separation article of claim 15, wherein the plurality of the asymmetric hollow fiber membranes is arranged in an array, wherein the array is pleated, folded, or rolled into a cylinder or a cassette.

17. The separation article of claim 15 or 16, wherein the separation article has a CO₂/N₂ selectivity of at least 10, optionally wherein the separation article has a CO₂/N₂ selectivity of up to 20.

18. The separation article according to claim 15, wherein the separation article has a CO₂ gas flux of at least 15 GPU, optionally wherein the separation article has a CO₂ gas flux of up to 65 GPU.

19. A method of making an asymmetric hollow fiber membrane according to of claim 1, the method comprising:
co-extruding a substrate resin comprising polypropylene and a skin layer resin comprising the copolymer comprising at least 80 weight percent 4-methyl-1-pentene units and at least 5 weight percent propylene units, to form an asymmetric fiber precursor; and
stretching the asymmetric fiber precursor to form the asymmetric hollow fiber membrane having a skin layer comprised of the skin layer resin overlaying a porous substrate comprised of the substrate resin surrounding the internal lumen, wherein the porous substrate comprises the plurality of pores.

20. The method of claim 19, further comprising annealing the asymmetric fiber precursor.
